(19) United States
(12) Patent Application Publication
(10) Pub. No.: US 2026/0153337 A1
(43) Pub. Date: Jun. 4, 2026

(54) SYSTEMS, METHODS, AND DEVICES FOR INDOOR TRACKING AND NAVIGATION

(71) Applicant: Met-Scan Canada Ltd., Toronto (CA)

(72) Inventor: Shermineh GHASEMI, Toronto (CA)

(21) Appl. No.: 19/400,541

(22) Filed: Nov. 25, 2025

Related U.S. Application Data
(60) Provisional application No. 63/726,367, filed on Nov. 29, 2024.

(51) Int. Cl. G01C 21/20; G06N 3/0464

(52) U.S. Cl. CPC G01C 21/206; G06N 3/0464

(57) ABSTRACT

Provided are methods, systems, and devices for indoor tracking and navigation. The method includes receiving a plurality of sensor signals and a navigational repository; integrating, by a fusion algorithm, the plurality of sensor signals and the navigational repository to generate a tempospatial guidance dataset; training a machine learning module on the tempospatial guidance dataset, wherein the machine learning model is configured to learn spatial patterns by analyzing relationships between the plurality of data signals and the navigational repository; and determining, by the machine learning module, a navigation signal for guiding a user, wherein the navigation signal is generated by analyzing a user location and predicted movement patterns.

### FIELD

The embodiments described herein generally relate to systems, methods, and devices for indoor tracking and navigation, and in particular to indoor tracking and navigation leveraging deep learning and multimodal data fusion.

### BACKGROUND

The following is not an admission that anything discussed below is part of the prior art or part of the common general knowledge of a person skilled in the art.

Existing indoor tracking and navigation systems are designed to provide location-based services in environments where traditional GPS is unreliable or unavailable, such as within buildings. These systems typically rely on technologies such as Bluetooth Low Energy (BLE) beacons, Wi-Fi signals and Radio Frequency Identification (RFID) which provide positional information. The goal of such systems is to locate and guide users through indoor spaces with a certain degree of accuracy and reliability, making them valuable in contexts like shopping malls, airports, hospitals, and large office buildings. In these systems, devices like access cards, smartphones, wearable devices, or other tracking modules communicate with the sensors or beacons installed throughout the indoor environment to determine the user's location. However, while they offer localized navigation support, these systems often encounter limitations in data processing efficiency, scalability, and accuracy, particularly when navigating complex or dynamic environments.

One of the primary shortcomings of existing indoor tracking systems is their reliance on single-modal data sources. Most systems use only one type of input, such as Bluetooth signals or Wi-Fi access points, to calculate location. This limited reliance often leads to challenges in accuracy, especially in environments with fluctuating signal strength, obstacles, or interference from other devices. For example, BLE beacons, while effective in large, open spaces, can struggle in densely built indoor environments where physical barriers obstruct signal propagation. Additionally, data from these systems typically require significant post-processing, and inefficiencies arise when the collected data lacks synchronization or when real-time processing is necessary. The lack of integration between different data sources contributes to delays and reduces the responsiveness of these systems.

Another challenge faced by indoor tracking systems is the difficulty in maintaining reliable tracking in dynamic environments, where factors such as temporary obstacles or changes in layout can reduce their effectiveness. In many cases, these systems do not update rapidly enough to provide users with the real-time accuracy needed for fluid navigation. Furthermore, traditional systems may also have limitations in their ability to scale across larger or multi-story environments, as they are often calibrated to specific zones or floors. This results in a limited range of usefulness, particularly when there is a need to integrate multiple floors or sections of a building.

The limitations of current indoor navigation systems are further pronounced when addressing the specific needs of people with disabilities. Individuals with visual, auditory, cognitive, or mobility impairments require systems that provide not only accurate location tracking but also intuitive, accessible guidance. Many existing systems focus primarily on general navigation solutions without considering the tailored needs of users with disabilities. For example, a visually impaired individual may require audio-based navigation instructions, while a wheelchair user may need information about the accessibility of routes, such as the presence of ramps or elevators. The lack of real-time obstacle detection and adaptive re-routing capabilities in many systems further restricts their effectiveness in catering to this group.

Solutions have been proposed to address the specific needs of people with disabilities, including smartphone-based navigation applications and systems utilizing BLE beacons. These systems offer promising approaches to assist individuals with visual impairments. BLE beacons, in particular, have been employed to enhance indoor localization accuracy in large environments, such as airports, hotels, and shopping malls. The integration of BLE beacons with smartphones enables these systems to estimate the user's location with reasonable accuracy. However, the reliance on BLE alone can be problematic due to signal interference and the inability to account for dynamic environmental factors, such as moving obstacles or temporary closures.

Several existing systems for people with disabilities also struggle with scalability and adaptability. While BLE-based systems may be effective in large, open spaces like airports, their performance in more complex environments, such as multi-story office buildings or crowded spaces, can suffer. This is especially relevant for users who require accessible paths, where real-time updates and obstacle detection are essential. For example, a visually impaired individual navigating through a crowded terminal would benefit from a system that not only provides directional guidance but also identifies areas of high crowd density and suggests alternate routes to avoid them.

Moreover, these existing systems often lack integration between different data sources, which could provide more accurate and responsive navigation. For instance, while BLE beacons offer positional data, integrating additional sensor inputs, such as infrared sensors, ultrasonic sensors, and video feeds, could significantly improve tracking precision and allow the system to better adapt to dynamic indoor environments. The absence of such multimodal data fusion in current solutions limits their ability to provide comprehensive navigation support for people with disabilities.

Therefore, the development of indoor tracking systems for people with disabilities requires solutions that go beyond conventional tracking technologies. Accordingly, there is a need for alternative systems and methods that can address the inefficiencies of the conventional systems.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least one embodiment, there is provided an indoor navigation system. The system includes a plurality of sensors to acquire a plurality of sensor signals, wherein the plurality of sensor signals include video data, motion detection data, environmental data, and proximity sensing data; a memory to store navigational repository, wherein the navigational repository includes architectural data, historical data, and user profile data; and a processor configured to: receive the plurality of sensor signals from the plurality of sensors; integrate, by a fusion algorithm, the plurality of sensor signals and the navigational repository to generate a tempospatial guidance dataset; train a machine learning model based on the tempospatial guidance dataset, wherein the machine learning model is configured to learn tempospatial patterns by analyzing relationships between the plurality of data signals and the navigational repository; and determine, by the machine learning model, a navigation signal for guiding a user, wherein the navigation signal is generated by analyzing a user location and predicted movement patterns.

In one or more embodiments, the plurality of sensors includes location identifier, motion detectors, infrared sensors, ultrasonic sensors, and real-time video feeds for detecting environmental conditions and user movements.

In one or more embodiments, the architectural data stored in the memory includes building layouts, locations of elevators, ramps, doorways, and accessibility features.

In one or more embodiments, the user profile data includes accessibility requirements, wheelchair-accessible paths, avoidance of stairs, and preferred elevator usage.

In one or more embodiments, the machine learning model is configured to continuously finetune predictions by analyzing the plurality of sensor signals and the navigational repository to adapt dynamically to changes in an indoor environment.

In one or more embodiments, the machine learning model predicts the navigation path by applying predictive algorithms to the tempospatial guidance dataset collected from sensors and cameras.

In one or more embodiments, the machine learning model predicts the navigation path by applying predictive tempospatial algorithms to locate and track a subject based on processing data received from various environments.

In one or more embodiments, the machine learning model is trained to analyze tempospatial data, wherein the tempospatial data includes time-stamped user movement patterns to predict peak usage times and determine optimal navigation routes based on the tempospatial data.

In another aspect, in at least one embodiment, there is provided an indoor navigation-device comprising: a sensor module configured to acquire a plurality of sensor signals; a data integration module configured to integrate, by a fusion algorithm, the plurality of sensor signals and a navigational repository to generate a tempospatial guidance dataset; a machine learning module configured to be trained and tested on the tempospatial guidance dataset, wherein the machine learning model is configured to learn tempospatial patterns by analyzing relationships between the plurality of data signals, video streams and the navigational repository; and the machine learning module further configured to determine a navigation signal for guiding a user, wherein the navigation signal is generated by analyzing a user location and predicted movement patterns.

In one or more embodiments, the plurality of sensors includes motion detectors, infrared sensors, ultrasonic sensors, and real-time video feeds for detecting environmental conditions and user movements.

In one or more embodiments, the architectural data stored in the memory includes building layouts, locations of elevators, ramps, doorways, and accessibility features.

In one or more embodiments, the user profile data includes accessibility requirements, wheelchair-accessible paths, avoidance of stairs, and preferred elevator usage.

In one or more embodiments, the machine learning model is configured to continuously finetune predictions by analyzing the plurality of sensor signals and the navigational repository to adapt dynamically to changes in an indoor environment.

In one or more embodiments, the machine learning model generates the navigation signal by applying predictive algorithms to the spatial guidance dataset, the user location and the predicted movement patterns.

In one or more embodiments, the machine learning model is configured to analyze temporal data, wherein the temporal data includes time-stamped user movement patterns to predict peak usage times and determine optimal navigation routes based on the temporal data.

In another aspect, in at least one embodiment, there is provided an indoor navigation method comprising: receiving a plurality of sensor signals and navigational repository; integrating, by a fusion algorithm, the plurality of sensor signals and a navigational repository to generate a tempospatial guidance dataset; training and test a machine learning module on the tempospatial guidance dataset, wherein the machine learning model is configured to learn tempospatial patterns by analyzing relationships between the plurality of data signals, video streams and the navigational repository; and the machine learning module further configured to determine a navigation signal for guiding a user, wherein the navigation signal is generated by analyzing a user location and predicted movement patterns.

In one or more embodiments, the plurality of sensors includes motion detectors, infrared sensors, ultrasonic sensors, and real-time video feeds for detecting environmental conditions, user movements and current location.

In one or more embodiments, the architectural data stored in the memory includes building layouts, locations of elevators, ramps, doorways, and accessibility features.

In one or more embodiments, the machine learning model is configured to continuously finetune predictions by analyzing the realtime plurality of sensor signals, video streams and the navigational repository to adapt dynamically to changes in an indoor environment.

In one or more embodiments, the machine learning model predicts the navigation path by applying predictive algorithms to the tempospatial guidance dataset, the user location and the predicted movement patterns.

### BRIEF DESCRIPTION OF THE DRAWINGS

For a better understanding of the embodiments described herein and to show more clearly how they may be carried out, reference will now be made, by way of example only, to the accompanying drawings which show at least one exemplary embodiment, and in which:

FIG. 1 is a block diagram of an example indoor tracking and navigation system 100 in accordance with an embodiment.

FIG. 2 illustrates a device architecture that supports both local-inference and remote-inference configurations. In a local-inference embodiment, a trained machine learning model is stored in memory (see machine learning model storage 228). In a remote-inference embodiment, the device communicates with a remote navigation server via a remote inference interface 230 implemented through the communications interface 2006.

FIG. 3 is a flowchart 300 of an example method for indoor tracking and navigation according to an embodiment.

FIG. 4 is a block diagram of an indoor navigation system illustrating the processor with the functional modules.

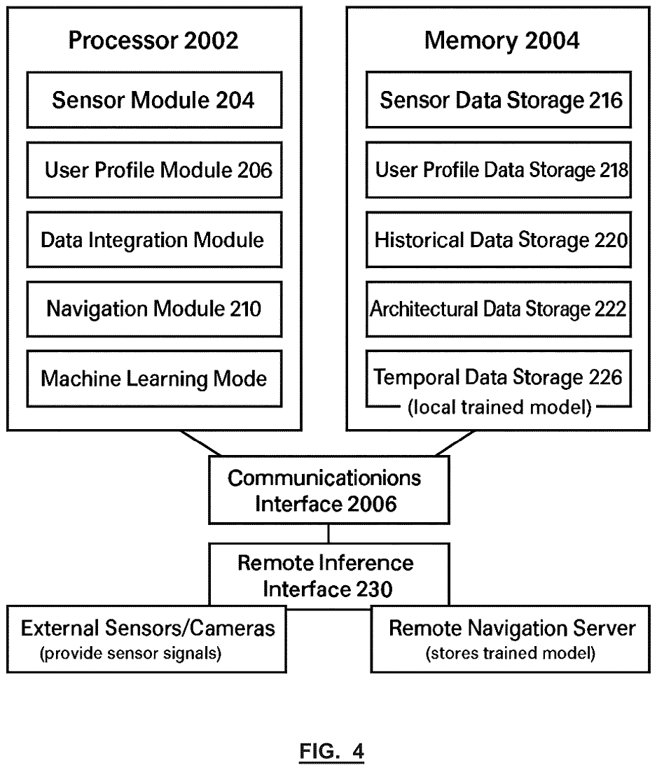

The skilled person in the art will understand that the drawings, described below, are for illustration purposes only. The drawings are not intended to limit the scope of the applicants'teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer-readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Existing indoor tracking and navigation systems, while useful in certain contexts, are limited in their effectiveness, particularly in dynamic and complex environments. These systems often rely on single-modal data sources, such as Bluetooth Low Energy (BLE) beacons, Wi-Fi signals, or Radio Frequency Identification (RFID). This reliance on a single type of data input can lead to inaccuracies, especially in spaces where signals are obstructed by physical barriers or experience interference. Additionally, existing systems frequently lack the ability to provide real-time responsiveness, as the processing of sensory data is often delayed or inefficient. These limitations make it difficult for users to receive timely guidance, particularly when navigating environments that are subject to frequent changes or that include multiple floors and sections.

Another challenge with current systems is the inability to adapt to dynamic conditions within indoor environments. Most existing systems are not equipped to handle temporary obstacles, such as construction or maintenance closures, nor do they offer effective re-routing options in real-time. Furthermore, the precision of these systems tends to degrade in environments that are densely populated or where multiple signals overlap. The lack of scalability across diverse building layouts also presents a barrier, particularly for large or multi-story environments where users may require continuous navigation support as they move between different sections of the space.

To address these challenges, the present disclosure introduces systems, methods, and devices that leverage multimodal data fusion and deep learning to provide improved tracking and navigation capabilities. By integrating sensor signals (such as infrared, ultrasonic, and motion detectors) with real-time video streams, this disclosure allows for more accurate and reliable determination of a user's position within indoor environments. This multimodal approach overcomes the limitations of single-modal systems by combining complementary data sources, resulting in improved localization, tracking precision, even in complex or obstructed environments.

In addition to improved data fusion, the systems, methods, and devices include predictive modeling capabilities that anticipate the user's intended destination based on historical movement patterns and real-time sensor inputs. This feature is particularly valuable for users with disabilities, as it allows the system to offer dynamic and context-sensitive guidance. The use of deep learning algorithms enables the system to continually refine its predictions and adapt to changing conditions, providing that users receive up-to-date navigation instructions that account for obstacles, crowd density, and accessibility needs.

Furthermore, the system is designed to integrate seamlessly with both existing sensor networks and newly installed sensors. This flexibility provides that the system can be implemented in a wide range of indoor environments, from older buildings with minimal technology infrastructure to modern facilities equipped with advanced sensor arrays. By addressing the inefficiencies of data processing, signal interference, and real-time adaptability, the disclosure offers a robust solution for individuals with disabilities, providing them with greater independence and confidence as they navigate complex indoor spaces.

In an embodiment, the systems, methods, and devices described herein provide an indoor tracking and navigation solution directed to the needs of individuals with disabilities. The disclosed embodiments leverage multimodal data inputs, combining sensor signals (such as infrared, ultrasonic, and motion detectors) with real-time video streams. This integration of diverse data sources improves the accuracy and reliability of indoor tracking, especially in environments where signal interference or physical barriers may impair the effectiveness of traditional systems.

In an embodiment, the disclosed systems, methods, and devices provide continuous, real-time tracking and navigation guidance. This is particularly important in complex indoor environments, such as multi-story buildings or facilities with dense foot traffic, where users with disabilities may require frequent updates to ensure they are on the correct path. The combination of sensor signals and video streams allows the system to maintain accurate positioning even in areas where traditional GPS tracking is unavailable. Additionally, the system can adapt to dynamic changes in the environment, such as temporary obstacles, by using predictive modeling techniques to adjust navigation guidance in real-time.

In an embodiment, an improvement in data processing efficiency is provided through the use of advanced deep learning techniques. By employing deep learning models, the system is capable of rapidly analyzing and interpreting the multimodal data it collects. This results in faster and more accurate positioning updates, enabling the system to provide users with near-instantaneous guidance. The system's ability to preprocess and synchronize data from various sensors and video inputs ensures that tracking information is continuously up-to-date, which is useful for individuals who rely on the system to navigate dynamic indoor spaces safely and efficiently.

The introduction of predictive modeling allows the system to anticipate a user's intended destination based on their movement patterns and previously stored data. For individuals with cognitive or mobility impairments, this predictive capability can be beneficial, as it reduces the need for constant user input and minimizes the risk of disorientation. By analyzing both historical data and real-time sensor inputs, the system is able to offer proactive guidance, rerouting users as needed to accommodate changes in the environment or their own navigation preferences.

Another improvement offered by the systems, methods, and devices is the adaptability to a wide range of indoor environments. Unlike existing solutions, which may require extensive infrastructure changes or rely heavily on pre-existing sensor networks, the present disclosure is configured to integrate with both old and new sensor systems. This flexibility allows for the seamless installation of the system in various settings, from older buildings that may lack sophisticated sensor arrays to modern facilities equipped with advanced monitoring technology.

The systems, methods, and devices are configured to improve accessibility for people with a range of disabilities, including auditory, visual, and cognitive impairments. For example, the system can provide audio-based navigation instructions for visually impaired users, while offering text-based guidance for individuals with hearing impairments. The system's ability to tailor its communication methods to the user's specific needs improves its usability and ensures that the guidance provided is both accessible and effective. This customization extends to the system's predictive capabilities, allowing it to adapt its navigation suggestions based on user feedback and preferences over time.

Furthermore, the systems, methods, and devices address the limitations of traditional indoor navigation systems that often struggle to provide accurate and timely information in environments where GPS signals are weak or nonexistent. By incorporating advanced sensor networks and video-based inputs, the system can provide precise tracking even in GPS-deprived settings, such as large buildings with complex layouts or underground facilities. This improvement is particularly valuable for individuals with disabilities, as it ensures they can navigate confidently and independently, regardless of the structural or technological limitations of the indoor space. Through the integration of deep learning, multimodal data fusion, and predictive modeling, the system represents an improvement in indoor tracking and navigation technologies.

The indoor tracking and navigation systems, methods, and devices described herein are designed to be used without limitation across a variety of indoor environments. The systems can be implemented in diverse architectural settings, including but not limited to multi-story office buildings, shopping malls, hospitals, airports, underground facilities, and open spaces such as courtyards, atriums, and large lobbies.

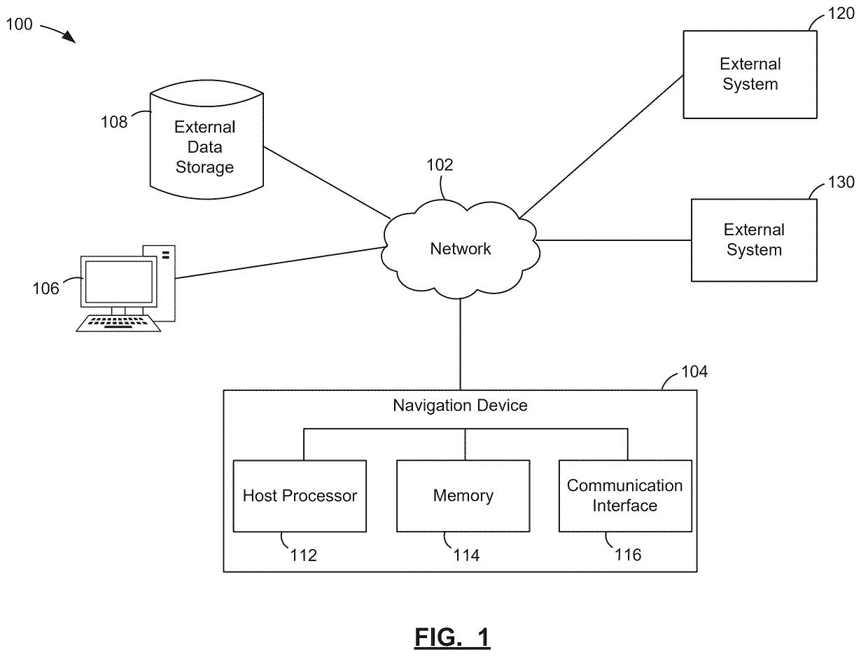

Reference is first made to FIG. 1, which illustrates an example block diagram of an indoor tracking and navigation system 100. System 100 includes a network 102 that connects multiple components of the system, providing for data transfer and communication. The system 100 further includes a navigation-device 104, which performs the core functions of indoor tracking and navigation. Additionally, a user terminal 106 is provided, which may be accessed by a user of the system 100 or an administrator for navigation monitoring and interaction purposes. External systems 120 and 130 are provided from where data access is made, allowing the system 100 to retrieve relevant information. The external systems 120 and 130 can include sensors, user input interfaces, building management systems, and environmental monitoring devices. The system 100 includes an external data storage 108.

The system representation shown in FIG. 1 is provided as an embodiment. There may be variations in the combination or number of such components, and in some cases, a single device may provide the functions of multiple components. For example, while FIG. 1 shows two external systems 120, 130, the system 100 may be in communication with fewer or a greater number of such external systems over a wide geographic area via network 102. Furthermore, while the external systems 120 and 130 are shown as separate components, in some cases, they can be the same devices performing both data provision and reception functions. External systems 120 and 130 may also be referred to as external sensors 120 and 130.

The navigation-device 104 includes a processor 112, a data storage 114, and a communications interface 116. Navigation-device 104 can be implemented with more than one computer server distributed over a wide geographic area and connected via network 102. Processor 112, data storage 114, and communications interface 116 may be combined into a fewer number of components or may be separated into further components. Navigation-device 104 is configured to process multimodal data, such as sensor signals and video streams, and to generate real-time navigation instructions. The processor 112 is configured to perform the processing of sensor signals, video streams, and other multimodal data to facilitate the generation of real-time navigation instructions. In the present disclosure, whenever the navigation-device 104 is described as performing data processing, such processing may be executed by processor 112. Memory 114 may provide storage for the instructions executed by the processor 112, as well as for the processed and unprocessed data.

Processor 112 can be implemented with any suitable processor, controller, digital signal processor, graphics processing unit, application-specific integrated circuits (ASICs), and/or field-programmable gate arrays (FPGAs) that can provide sufficient processing power for the configuration, purposes, and requirements of the navigation-device 104. Processor 112 can include more than one processor with each processor being configured to perform different dedicated tasks.

Processor 112 can be configured to control the operation of the navigation-device 104. For example, processor 112 can execute instructions to manage data retrieval from external systems 120, 130, providing continuous updates and accurate data acquisition. Processor 112 ensures the real-time processing of multimodal data, enabling accurate tracking and predictive navigation for users in indoor environments.

The communications interface 116 can include any interface that enables the navigation-device 104 to communicate with various devices and other systems. For example, the communications interface 116 can receive input signals from external systems 120, 130 such as sensors, video cameras, and user input devices. In an embodiment, the communications interface 116 receives input signals from the external data storage 108. The input signals may include data relevant to real-time location tracking, obstacle detection, and environmental changes. Processor 112 can then process these input signals by applying deep learning algorithms for pattern recognition and predictive modeling. Thereafter, processor 112 can categorize the data into relevant categories such as user location, environmental conditions, and predicted routes. Processor 112 can also perform normalization to ensure data completeness. Processor 112 can execute predictive algorithms to determine the user's intended destination based on historical movement patterns and current data inputs.

The communications interface 116 can include at least one of a serial port, a parallel port, or a USB port, in some embodiments. The communications interface 116 may also include interfaces via one or more of an Internet connection, Local Area Network (LAN), Ethernet, FireWire, modem, fiber, or digital subscriber line connection. Various combinations of these elements may be incorporated within the communications interface 116.

In one embodiment, the navigation-device further comprises a natural-language interaction module configured to receive and interpret user commands expressed in natural language. The module includes a speech-to-text subsystem, a language understanding subsystem, and an intent-recognition engine. The language understanding subsystem employs a large language model trained on multimodal navigation data to parse user queries and extract structured intents corresponding to destinations, constraints, and preferences.

For example, upon receiving a spoken command “Guide me to the nearest accessible washroom avoiding crowds,” the natural-language interaction module determines a navigation goal of washroom, applies accessibility constraints from the user profile, and queries the environmental data storage for crowd density metrics. The resulting structured command is transmitted to the navigation module for route computation and guidance signal generation.

The module further includes a natural-language generation subsystem configured to generate context-aware responses in text or speech form, such as “Turn left in 10 meters; elevator access ahead.” The interaction module thereby provides intuitive, language-based control of the navigation system, improving usability for users with varying accessibility needs.

The data storage 114 can include RAM, ROM, one or more hard drives, one or more flash drives, or some other suitable data storage elements such as disk drives. The data storage 114 can store the extracted and processed data. The data storage 114 can also store the instructions executed by processor 112. Additionally, the data storage 114 can maintain logs of all transactions and updates.

In some embodiments, the external data storage 108 can be a third-party data storage system. The data stored in the external data storage 108 can be retrieved by the navigation-device 104 via the network 102.

The external systems 120, 130 can include a processor and memory. The external systems 120, 130 can interact with the navigation-device 104 to provide and receive data for real-time navigation assistance, environmental monitoring, and user input management. For instance, the external system 120 can be associated with a building management system that monitors elevators and accessible routes.

The external systems 120, 130 can include sensors, video cameras, environmental monitoring devices, motion detectors, infrared sensors, real-time video cameras, ultrasonic sensors, and user input interfaces such as touchscreens or voice command systems. The external systems 120, 130 may also include building management systems, smart devices, wearable technology, and mobile devices. The data received by these systems can vary widely, including real-time location data, environmental conditions (such as temperature, lighting, or crowd density), user interactions, and inputs related to accessibility features like elevators or ramps. Alternatives and variations of external systems may include advanced imaging devices, RFID scanners, or smart beacons, each capable of transmitting different types of data such as object proximity, movement patterns, or personalized user preferences, contributing to enhanced indoor tracking and navigation functionality.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these, capable of interfacing with, and enabling communication between, the navigation-device 104, the external systems 120 and 130, and the external data storage 108 and the user terminal 106.

The user terminal 106 can include a processor and memory, and may be a computer, tablet, workstation, portable computer, mobile device, personal digital assistant, laptop, or any combination of these devices. Separate user terminals 106 may exist for multiple users, including end-users, assessors, and administrators.

For end-users, the user terminal 106 may provide an interface to input navigation requests, receive real-time guidance through audio or text-based prompts, and offer feedback on the accessibility and usability of suggested routes. End-users can also view their current location, navigate through interactive maps, and receive alerts on potential obstacles or route updates.

For administrators, terminal 106 may allow for the monitoring of system performance, updating sensor or system settings, and reviewing user feedback for system optimization. Administrators may also use the terminal to manage user profiles, configure accessibility preferences, and troubleshoot connectivity or data processing issues within the system.

The external systems 120, 130 can include a plurality of sensors that are either pre-existing in the building infrastructure or installed as part of the system's deployment. These pre-existing sensors, including infrared sensors, ultrasonic sensors, and motion detectors, are configured to collect data to support real-time indoor tracking and navigation. If a building is already equipped with sensors, the system 100 can integrate seamlessly with them to leverage the existing sensor infrastructure. This integration allows for data acquisition without the need for extensive new sensor installations. The integration process includes establishing a communication link between the existing sensors and the navigation-device 104 via the network 102, allowing the system to gather real-time data that is then processed for tracking and navigation purposes.

In an embodiment, before integrating existing sensors into the system 100, the navigation-device 104 is configured to perform an automated compatibility assessment. The compatibility assessment provides that the sensors meet the operational requirements of the system 100, including data quality, frequency of updates, coverage areas, and overall performance. The navigation-device 104 retrieves and analyzes sensor parameters, such as signal range, resolution, and data transmission rates. The navigation-device 104 automatically cross-references the parameters with predefined thresholds required for accurate indoor tracking and navigation. For example, the navigation-device 104 processes the sensor's data to assess its positional accuracy by comparing sensor outputs with known environmental features, ensuring the sensor provides reliable location data.

Additionally, navigation-device 104 performs latency and update frequency tests by measuring the time intervals between data transmissions and evaluating whether these intervals meet the system's 100 real-time processing requirements. The navigation-device 104 can simulate navigation scenarios to validate whether the sensor's data can be used effectively for continuous, real-time updates. The navigation-device 104 also maps the coverage area of each sensor, using algorithms to detect potential gaps in sensor range. Navigation-device 104 generates a visual map, viewable on terminal 106, that highlights zones where additional sensors may be needed to ensure full environmental monitoring and navigation accuracy.

In an embodiment, the navigation-device 104 monitors sensor inputs for inconsistencies or performance degradation to flag sensors that do not meet operational standards. If gaps in coverage or insufficient update frequencies are detected, the navigation-device 104 generates alerts and proposes optimized sensor placement or additional sensor installation as needed to maintain system integrity.

When the existing sensor network does not provide sufficient coverage or data quality, or if no sensor infrastructure is available, the 100 system is configured to integrate with new sensors as the external systems 120, 130. The navigation-device 104 performs an automated analysis to select sensors based on the specific requirements of the environment. For example, the navigation-device 104 may select infrared sensors for detecting movement in low-light areas or ultrasonic sensors for proximity detection in narrow spaces. In an embodiment, the navigation-device 104 is configured to perform a spatial mapping of the environment. Navigation-device 104 identifies key areas such as entry points, corridors, elevators, and stairwells to identify locations to provide sensor coverage for seamless tracking and navigation.

Once the appropriate sensors are selected, the navigation-device 104 is configured to identify optimal placement of sensors. The navigation-device 104 uses algorithms to generate a placement map, ensuring sensors are positioned in areas for tracking and navigation, such as doorways, intersections, and shared spaces. The navigation-device 104 computes the maximum coverage for each sensor while minimizing interference and overlap.

In an embodiment, after new sensors are installed, the navigation-device 104 is configured to automatically initiate a calibration process. Navigation-device 104 is configured to adjust a sensor to account for environmental conditions such as light levels, surface reflections, and potential interference. Navigation-device 104 synchronizes all sensors in terms of timestamping, providing that data from multiple sensors is processed in real-time without any delay or misalignment.

In an embodiment, the navigation-device 104 operates on a hybrid approach by integrating both existing sensors and newly installed sensors. Navigation-device 104 may analyze the performance of the existing sensor network by assessing data quality, coverage, and real-time responsiveness. If gaps or inefficiencies are detected, the navigation-device 104 determines optimal placement for new sensors to improve coverage and accuracy. The navigation-device 104 then synchronizes the data streams from both old and new sensors, providing for seamless data fusion.

To provide seamless operation, the navigation-device 104 is configured to integrate data from both old and newly installed sensors. In addition to sensor data, the video cameras may provide a supplementary layer of data for navigational analysis. The real-time video feeds from these cameras complement sensory inputs by capturing visual information about the environment. The real-time video feed allows detecting dynamic changes, such as people moving through a hallway, temporary obstacles like construction barriers, or changes in crowd density. Navigation-device 104 may process the video data by computer vision algorithms to detect and identify obstacles, adjusting routes in real-time to accommodate for these changes and ensuring the user's path remains accessible and safe.

In an embodiment, the navigation-device 104 receives a combination of architectural data, user feedback, and real-time environmental sensing from the sensors to determine and suggest accessible routes for wheelchair users in multi-story office buildings.

In an embodiment, the architectural data is stored in external data storage 108. The architectural data includes building layouts, identifying elevators, ramps, doorways, and other accessibility features. Navigation-device 104, upon receiving the architectural data from the external data storage 108, processes this data to map the available routes within the building.

In an embodiment, the external data storage 108 stores a navigational repository. The navigational repository includes historical data collected by the system on individual user movements within the indoor environment. The historical data includes frequently taken routes, commonly visited destinations, and the amount of time spent in various locations for a specific user or a group of users. The external data storage 108 organizes the historical data in a structured format, creating time-stamped records for each movement instance. Navigation-device 104, upon receive the historical data from the external data storage 108, processes the historical data to build user movement patterns over time. The data structure includes fields for location identifiers, timestamps, and duration of stay at each location. The external data storage 108 stores the movement patterns in a relational database, allowing the navigation-device 104 to retrieve and analyze historical movement data to predict future navigation needs

In an embodiment, the external data storage 108 stores navigational repository including user profile data. The user profile data includes user identifier and corresponding user navigation data. The corresponding user navigation data includes data representation of preferred routes, frequently visited locations, and accessibility requirements such as wheelchair-accessible paths or elevator usage. The user navigation data also includes historical movement patterns, route completion times, and feedback on route effectiveness. Each user may have a personalized profile that includes preferred routes, frequently visited destinations, and accessibility needs. The system 100 receives data related to the user's mobility preferences, such as wheelchair access requirements, and frequently used building services, such as specific elevators, restrooms, or conference rooms. In an embodiment, the user navigation data includes data representation on specific user preferences, such as avoiding stairs, preferring elevators, or selecting routes with accessible restrooms. The user profile data can be gathered automatically through sensors detecting the specific user's interactions with the navigation services or manually inputted through the user interface on the terminal 106. The external data storage 108 stores the preferences in a structured profile format, with fields for route preferences, accessibility requirements, and frequently visited locations. The navigation-device 104 retrieves the user profiles to customize navigation suggestions based on the user's preferences.

The user profile data includes user feedback data. After a navigation session, the terminal 106 may receive user feedback. The terminal 106 is configured to update the user's profile data in the external data storage 108 accordingly. Feedback data may include data representations of satisfaction ratings, suggested route improvements, and accessibility challenges encountered. The navigation-device may process the user feedback data by categorizing the user feedback data into relevant areas such as route efficiency, accessibility of suggested paths, and user preferences. The navigation-device 104 analyzes the feedback and refines its future predictions, continuously improving the navigation-device's 104 ability to provide personalized navigation guidance.

The external data storage 108 is configured to continuously update the user profiles as new feedback or data becomes available. The external data storage 108 may use an indexed data structure for efficient retrieval and update operations.

The communications interface 116 of the navigation-device 104 is configured to receive various datasets from indoor environments. Additionally, the communications interface 116 collects real-time video feeds from strategically placed cameras that monitor areas such as hallways, doorways, and common spaces.

In some embodiments, the communications interface 116 employs authenticated and encrypted channels for data exchange with external systems and user terminals. Access to the navigational repository may be governed by role-based permissions, audit logging, and data minimization policies. When on-device inference is used, sensitive user profile data and time-stamped movement information may be processed locally to reduce network exposure and support privacy-preserving operation. In remote-inference configurations, the device can transmit a minimal feature representation derived from the fused inputs, thereby limiting transmission of raw video frames or personally identifiable information while preserving accuracy for route computation.

Environmental data received by the sensors 120, 130 include data representations on a user's interaction with specific features such as interactions with elevators, doors, and information kiosks. If a sensor detects a user calling an elevator, a signal may be sent to the navigation-device 104. Navigation-device 104 may predict an intention to move to a different floor. Similarly, frequent visits to conference rooms or cafeterias may help the system anticipate future movements based on historical patterns.

Environmental data may provide real-time adjustments to navigation suggestions. The sensors 120, 130 are configured to use video and sensor data to detect temporary obstacles, such as construction zones or blocked pathways. The environmental data allows the navigation-device 104 to adjust the user's route in real-time, avoiding these barriers. Additionally, sensors 120, 130 may monitor crowd density. The navigation-device 104 may analyze real-time sensor inputs and video feeds to assess crowd levels in different areas to redirect users, such as users with mobility challenges, away from congested areas that could be difficult to navigate.

In an embodiment, the navigation-device 104 is configured to process temporal data for predictive modeling for user destinations. The navigation-device 104 retrieves time-stamped user movement data from the external data storage 108, including logs of previous navigation events and visits to specific locations. Navigation-device 104 may process or receive sensor data from external systems 120, 130. Navigation-device 104 analyzes the data to identify patterns associated with the time of day. For instance, the navigation-device 104 may detect that users tend to visit entry points during specific time windows, such as early mornings or late afternoons, which correlates with arrival or departure times. The navigation-device 104 stores temporal patterns in a structured format, categorizing locations and times in relational databases for efficient retrieval. For example, the navigation-device 104 maps frequent lunchtime visits to common areas, such as cafeterias or break rooms, and associates these patterns with specific time intervals. Similarly, the system tracks day-of-the-week patterns, where certain destinations, like meeting rooms, are accessed more often on weekdays, while recreational areas are used more frequently on weekends. The temporal data may be cross-referenced with environmental data, such as real-time crowd density, and user profile data to refine navigation predictions.

In an embodiment, the navigation-device 104 is configured to process and integrate a plurality of data. The integration process leverages predictive algorithms that analyze inputs from multiple sources, including sensor data, user profiles, historical data, architectural data, environmental data, and temporal data. Navigation-device 104 receives the data types from the external systems 120, 130, and the external data storage 108. By analyzing the diverse dataset, the navigation-device 104 predicts the user's intended destination and generates optimized routes.

Navigation-device 104 provides advanced data fusion techniques to merge the data inputs into a unified data stream. The fusion process accounts for different data formats and synchronizes them for real-time processing. Using this integrated dataset, the navigation-device 104 generates personalized navigation suggestions, adapting routes in real-time based on the time of day, day of the week, and the user's typical navigation behaviors.

In an embodiment, the navigation-device 104 is configured to integrate, by a fusion algorithm, the plurality of sensor signals and the navigational repository to generate a tempospatial guidance dataset. Navigation-device 104 can integrate and process multimodal data to improve the accuracy of indoor tracking and navigation. The navigation-device 104 fuses data from various sensors, such as infrared, ultrasonic, and motion detectors, along with real-time video stream data from strategically placed cameras. The fusion process allows the system 100 to create a comprehensive understanding of the indoor environment, mapping both static elements like walls and doors and dynamic changes such as moving obstacles or varying crowd densities. The integration of the data sources enables the navigation-device 104 to continuously monitor the environment and adjust navigation suggestions accordingly. Architectural data, such as building layouts and accessible features, is incorporated to ensure that the generated routes account for the physical infrastructure of the space, including elevators, ramps, and wide doorways for wheelchair users.

The navigation-device 104 further processes historical data, user profile data, and user feedback data to generate route suggestions that are customized to the individual user's mobility needs. The historical data provides insight into frequently traveled routes and common destinations, while user profiles store personalized preferences such as avoiding stairs or preferring certain elevators. When a user interacts with the system 100, the navigation-device 104 retrieves and applies the stored profile to the current conditions. User feedback, collected after each navigation session, is used to refine future route suggestions by learning from past experiences. Navigation-device 104 generates optimal, accessible paths tailored to both real-time environmental conditions and the specific needs of users such as those on wheelchair, providing that all suggested routes align with the user's accessibility requirements. The navigation-device 104 processes temporal data, such as time of day and day of the week, to further refine its route suggestions. By analyzing patterns of user movements during specific time periods, the system 100 can anticipate when certain areas may be crowded or more accessible. For example, it may suggest quieter routes during peak times or guide users to frequently visited destinations based on common time-based preferences, such as lunch hours or scheduled meetings.

Navigation-device 104 provides data collection, preprocessing, and synchronization. The navigation-device 104 receives data from multiple sensors 120, 130 and video signals in real-time. The data is preprocessed to remove noise, inconsistencies, and redundant information. Navigation-device 104 performs data cleaning operations, which include filtering out corrupted data and managing incomplete data records. In an embodiment, the navigation-device 104 executes data transformation techniques to convert data into formats suitable for further analysis. Navigation-device 104 can synchronize the incoming data streams to provide temporal alignment, allowing for coherent integration across diverse sensor inputs and real-time video data. The preprocessing provides for a consistent dataset that the navigation-device 104 uses for training models and decision-making.

Navigation-device 104 integrates sensor data to complement the visual information extracted from the video streams. Ultrasonic sensors can be used to measure the distance to nearby objects, improving the spatial accuracy of the navigation system. For example, by providing precise distance measurements, ultrasonic data is processed by the navigation-device 104 to refine the location of walls or obstacles detected by video feeds. Additionally, infrared sensors can detect heat signatures, distinguishing between inanimate objects and living beings, such as people. The data from the infrared sensors is processed by the navigation-device 104 to improve object detection.

Navigation-device 104 is configured to integrate data from various sensors and real-time video streams 120, 130 by fusion algorithms. The fusion process provides for building a comprehensive representation of the indoor environment. Sensor data from motion detectors, ultrasonic sensors, and infrared sensors is combined with video data to create a unified view of the user's surroundings. The fusion algorithms reconcile the different data types and formats to provide consistency. By merging these inputs, the navigation-device 104 improves its localization accuracy and provides precise navigation instructions, which dynamically adjust based on the user's real-time location and environmental conditions.

In an embodiment, upon receiving raw data from the API, the navigation-device 104 performs a series of preprocessing steps to prepare the data for use in neural network models. The preprocessing includes data cleaning, which further includes removing irrelevant or noisy data points, and data transformation, which converts the data into structured formats that the network can process. Additionally, the navigation-device 104 improves the data quality by filling in gaps or missing values and normalizing the dataset to ensure consistency. The preprocessing provides from transforming the raw, unstructured data is converted into a usable form that can be analyzed effectively by the neural network.

In an embodiment, the navigation-device 104 is configured to apply fusion algorithms to reconcile data points from different data sources into a coherent model of the user's environment. The fusion process improves the accuracy of the system by using the combined strengths of multiple sensor types. By analyzing the data inputs together, the navigation-device 104 can pinpoint the user's location more precisely than it could with any single sensor type alone.

In an embodiment, the data fusion process allows the navigation-device 104 to determine the user's location within an indoor space without relying on GPS. The real-time integration of data enables the navigation-device 104 to efficiently adapt to changes in the environment or the user's movement, providing that navigation instructions remain accurate.

In an embodiment, the navigation-device 104 is configured to organize the incoming data from individual beacons rather than general Wi-Fi access points. The adjustments improve the tracking of specific beacon movements and improve localization accuracy.

Navigation-device 104 implements several fusion techniques to maximize the accuracy and reliability of its location predictions. In an embodiment, the navigation-device 104 is configured to provide feature fusion, which extracts relevant features from both sensor and video data and combines them to make more informed predictions. In an embodiment, the navigation-device 104 is configured to provide weighted average prediction, where separate predictions from sensor and video data are combined based on their reliability. For example, video data may provide a clearer prediction in a visually dynamic environment, while sensor data can be used when video inputs are limited. Navigation-device 104 may also provide a fallback mechanism when video data is unavailable or unreliable, relying primarily on sensor inputs for prediction.

The navigation-device 104 is configured to integrate architectural data, such as building layouts that include the location of elevators, ramps, wide doorways, and accessible restrooms. The architectural data is used in combination with the sensor and video data to provide more contextual navigation suggestions. For example, the navigation-device 104 can dynamically check the status of accessibility features, such as whether an elevator is operational or whether a ramp is temporarily blocked.

Navigation-device 104 may continuously collect real-time data from embedded sensors distributed throughout the building to monitor the status and availability of critical accessibility features. Sensors can be placed near elevators, automatic doors, and ramps to capture specific data, such as whether an elevator is in operation, its current floor position, or whether a ramp is temporarily blocked. The sensor data from the sensors is transmitted to navigation-device 104 via the communication interface 116. The navigation-device 104 processes sensor data to check the status of these features. If an accessibility feature is unavailable, such as an out-of-service elevator, the navigation-device 104 dynamically adjusts the navigation routes, providing users with accessible alternatives in real-time.

In an embodiment, the navigation-device 104 applies time synchronization techniques to provide that the data streams from multiple sources, such as sensors, video feeds, and building management systems, are aligned in time. The synchronization provides a coherent dataset for the system's decision-making process, allowing it to process real-time data and make accurate predictions without discrepancies or delays.

In an embodiment, the navigation-device 104 is configured to transform raw sensor data into formats suitable for processing by its algorithms. For example, grid maps may be provided for processing by a convolutional neural network (CNN). In an embodiment, RSSI (Received Signal Strength Indicator) values are converted into visual formats interpretable by the network, allowing it to process the data for location tracking. To handle any inconsistencies in data collection, such as missing timestamps, the navigation-device 104 applies data management techniques such as forward-filling missing values to ensure continuity without discarding useful information. The feature provides for continuity of the data stream without discarding incomplete data, allowing for consistent processing and analysis.

As the user navigates through the indoor space, the navigation-device 104 continuously tracks their position and movement trajectory using sensor and video data. The navigation-device 104 updates the user's location in real-time by integrating inputs from motion detectors, infrared sensors, and video feeds. The data is processed using fusion algorithms to calculate the user's current position and movement path. The navigation-device 104 is configured to predict the user's intended destination by analyzing their real-time movement patterns in conjunction with historical data and user profile information. The continuous data fusion provides for the navigation-device 104 to adjust the user's path dynamically.

The navigation-device 104 is configured to perform feature extraction from the video streams and data signals received from the cameras. Navigation-device 104 processes video data using computer vision techniques to identify relevant features for navigation, such as the positions of walls, doors, and other static landmarks. To identify dynamic obstacles, such as moving people or temporary barriers, the navigation-device 104 applies edge detection and motion tracking algorithms. Object recognition is also utilized to distinguish between various objects in the environment. The navigation-device 104 continuously updates these extracted features to ensure real-time accuracy as the user navigates through space. Navigation-device 104 provides for dynamically adjusting the navigation routes based on real-time environmental conditions.

In an embodiment, the navigation-device 104 is configured with multiple deep learning models to support its indoor tracking and navigation functionality. The deep learning models include an indoor tracking model to learn spatial patterns from the multimodal data collected from sensors and video streams. The indoor tracking model is trained to accurately track the user's position in real-time by analyzing the spatial relationships between the sensor data and the user's movement through the indoor environment. The model utilizes convolutional neural networks (CNNs) to detect spatial features and continuously refine its predictions based on new data, enabling precise location tracking within dynamic indoor environments.

In an embodiment, the navigation-device 104 includes a neural network that combines Convolutional Neural Networks (CNNs) and Artificial Neural Networks (ANNs) to process the data for indoor localization. In an embodiment, the navigation-device 104 is configured to transform the input data into a 19×18 grayscale matrix. The matrix represents the RSSI (Received Signal Strength Indicator) strength from each Wi-Fi access point or beacon. The matrix is used as input for the CNN, which identifies spatial features. The spatial features are also processed by the ANN processes to predict the user's location within the environment. The hybrid neural network model enables the navigation-device 104 to accurately interpret data and provide precise localization in real-time.

In an embodiment, the host processor 112 in the navigation-device 104 is configured to provide deep learning to analyze and interpret multimodal data. The host processor 112 executes deep learning models to process data from sensors and video streams, enabling accurate predictions of user positions and intended destinations. The deep learning models are trained to handle tasks such as object recognition, motion analysis, and environmental mapping. The host processor 112 is configured to process the fused data from multiple sources to track the user's position in real-time. The models also utilize historical data and movement patterns to predict the user's next destination, adapting based on user behaviors and environmental changes.

The deep learning models are configured to be trained on the spatial guidance dataset. The machine learning model is configured to learn spatial patterns by analyzing relationships between the plurality of data signals and the navigational repository. The deep learning models can execute predictive algorithms to anticipate the unique movement patterns of users, particularly those with disabilities. The navigation-device 104 executes the predictive algorithms to learn from previous interactions and continuously refine its predictions. For instance, the navigation-device 104 adapts to users'navigation preferences over time, to offer optimized routes based on historical behavior and current environmental conditions.

The navigation-device 104 executes deep learning models directed to analyze the rich multimodal data collected from the plurality of sensors and video streams. The deep learning models enable the navigation-device 104 to make accurate predictions about user positions and intended destinations by analyzing patterns in the data. The deep learning models can adapt and learn from new environmental conditions and user behaviors, allowing the navigation-device 104 to continuously improve its performance over time. By leveraging the flexibility of deep learning, the navigation-device 104 becomes more effective at adjusting to changes in the environment, such as dynamic obstacles or crowd density, while providing personalized navigation assistance to users.

The CNN structure of the navigation-device 104 is designed to optimize feature extraction. The initial layers focus on detecting spatial patterns from the input matrix, allowing the system to condense the raw data into meaningful representations. The max-pooling layers reduce the complexity of the data while preserving important features. After the data is flattened, it is passed through a fully connected ReLU-activated network, which refines the features further before classification.

For classification and output, the SoftMax activation layer generates probability distributions over the possible user locations. The probability vectors represent the confidence levels for each zone and are used by the ANN to provide the final classification of the user's location. The layered architecture enables the navigation-device 104 to achieve high accuracy in indoor localization, ensuring reliable guidance for users as they navigate through the environment.

In an embodiment, as an alternative to traditional machine learning algorithms, such as K-Nearest Neighbors (KNN), the navigation-device 104 employs a combined Convolutional Neural Network (CNN) and Artificial Neural Network (ANN) approach. The hybrid model can be implemented using a deep learning framework to provide robust and accurate predictions. The hybrid model converts longitude and latitude coordinates into XY coordinates. Further, the hybrid model transforms RSSI (Received Signal Strength Indicator) data from Bluetooth Low Energy (BLE) beacons into a matrix. The intensity of different shades in the matrix corresponds to RSSI values, representing the signal strength from each beacon.

The CNN used in the hybrid model of the navigation-device 104 comprises multiple layers, including a convolutional ReLU-activated layer with a 7×7 kernel, followed by a 2×2 max-pooling layer to reduce the spatial dimensions and focus on the most important features. Another convolutional ReLU-activated layer with a 3×3 kernel is followed by an additional 2×2 max-pooling layer. The hybrid model extracts and condenses spatial features from the input matrix, allowing the model to capture important characteristics related to the user's position. After the features are extracted, the data is flattened into a one-dimensional array and passed through a fully connected ReLU-activated layer with 128 nodes to further refine the learned features.

Once the features are fully extracted and processed, the output is passed through a SoftMax activation layer, which generates probability vectors indicating the likelihood of the user being in one of 21 predefined zones. The probability vectors are input into an ANN, which performs the final classification, determining the most likely zone where the user is located. The structure enables the navigation-device 104 to provide precise indoor localization by accurately interpreting the RSSI data.

For example, the CNN-ANN model can be trained using a dataset of multiple images collected from various distinct locations within the indoor environment. An image can be taken periodically to build a comprehensive database for training and validation. The model may be trained over a plurality of epochs using a batch size of 10, with the legacy Adam optimizer and categorical cross-entropy loss function. The training can be conducted with an 80/20 split between training and validation data to ensure that the model was both accurate and generalizable. Accuracy metrics can be used to evaluate the model's performance to predict user locations effectively.

The tracking and navigation models are trained using a preprocessed dataset collected from the indoor environment. The preprocessed data includes sensor signals, video feeds, and user movement patterns. The navigation-device 104 is configured to train these models by running them through multiple training epochs, during which the models learn to detect spatial patterns and predict destinations based on the dataset. Once trained, the models are validated using a separate validation dataset to ensure that they generalize well to new, unseen data.

After the models are trained and validated, the models are integrated into a unified application for indoor tracking and navigation. The navigation-device 104 is configured to deploy these models within a real-time processing framework that can handle continuous data inputs from sensors and video streams.

In an embodiment, the navigation-device 104 implements object recognition by convolutional neural networks (CNNs) to analyze video feed data for identifying obstacles and landmarks in real-time. The video and sensor data are processed through the CNN to detect features such as walls, doors, furniture, and temporary obstacles like moving people or construction signs. The CNN architecture allows the system to continuously monitor the environment and update the navigation path to avoid obstacles. The navigation-device 104 also incorporates deep learning for object recognition and motion analysis, enabling instant recognition of new obstacles or landmarks in the user's path. If an obstacle, such as furniture or signage, is detected by the object recognition module, the navigation-device 104 recalibrates the navigation path to bypass the obstacle. The dynamic recalibration is achieved by processing the visual data through CNNs and generating updated navigation routes in real-time. The motion analysis component, powered by Recurrent Neural Networks (RNNs) and Long Short-Term Memory (LSTM) networks, analyzes user movement patterns.

The navigation-device 104 is configured to perform environmental mapping using a combination of CNNs and Graph Neural Networks (GNNs). The deep learning models generate dynamic maps of the indoor environment, which are updated continuously with sensor and video data.

The navigation-device 104 is configured to provide user intent prediction. By analyzing the user's movement patterns and previous navigation choices, the navigation-device 104 predicts the intended destination. The navigation-device 104 uses machine learning models, such as decision trees and Bayesian networks, to refine its predictions over time, learning from each user's individual behavior.

The navigation-device 104 also updates its spatial mapping feature as the environment changes. Deep learning models construct and update a three-dimensional map of the indoor environment, capturing both the static layout and any temporal changes, such as moving furniture or doors opening and closing. The combination of sensor data and video inputs enables the system to generate a detailed 3D map, which provides a real-time representation of the space.

In an embodiment, the deep learning models include pattern recognition models within the navigation-device 104 to analyze data over time to improve the precision of the tracking system. By learning from user movement patterns and environmental changes, the navigation-device 104 refines common navigation routes and obstacles.

In an embodiment, the deep learning models execute adaptive navigation algorithms to dynamically adjust suggested routes based on real-time data about the environment and the user's current status. The algorithms consider factors such as obstacles, user speed, and environmental conditions to calculate the most efficient path from the user's current location to their intended destination. The path planning and obstacle avoidance algorithms in the navigation-device 104 utilize the fused data from sensors and video feeds to calculate optimal routes. The algorithms dynamically adjust the user's path in real-time, accounting for any obstacles or changes detected in the environment.

In an embodiment, the navigation-device 104 is configured to process external factors such as event schedules, area occupancy, and crowd density. If the building hosts events, the navigation-device 104 may receive data regarding the event's time, location, and nature. The event data is integrated into the predictive models to forecast user movements toward the event venues. For example, during event times, the system can anticipate increased traffic in certain areas and adjust navigation paths accordingly. The navigation-device 104 also collects real-time occupancy and crowd density data from sensors and video feeds.

The navigation-device 104 utilizes adaptive learning techniques by machine learning algorithms. By continuously learning from the fused sensor and video data, the system improves its ability to predict and respond to changes in the environment and user behavior.

In an embodiment, a feedback loop is integrated into the navigation-device 104, allowing users to provide real-time feedback on the efficacy and comfort of the suggested routes. This feedback is processed by the system and incorporated into the data analysis and fusion processes. For instance, users can report obstacles or rate the accessibility of suggested routes.

In an embodiment, the navigation-device 104 provides dynamic re-routing. If a typically accessible route becomes unavailable due to maintenance or a temporary blockage, such as a broken elevator or a blocked ramp, the system immediately recalculates and suggests an alternative accessible route.

In an embodiment, the navigation-device 104 integrates with building management systems to receive updates about maintenance schedules, emergency situations, and changes affecting accessibility.

In an embodiment, the navigation-device 104 is configured to provide intuitive user interaction by employing deep learning models that process complex inputs and deliver simple, intuitive outputs. For instance, for a visually impaired user, the navigation-device 104 delivers, at the terminal 106, audio cues that are clear and easy to follow, guiding the user through the indoor environment. For users with mobility challenges, the navigation-device 104 sends notifications about accessible paths, such as routes that avoid stairs and prioritize elevators or ramps.

The communication interface 116 of the navigation-device 104 is configured to receive different types of data from a network of sensors distributed throughout the indoor environment. The sensors include, but are not limited to, infrared sensors, motion detectors, and ultrasonic sensors, which provide real-time inputs related to the user's position and environmental conditions. The data collected from these sensors serves as the foundation for training and validating the deep learning models. By continuously receiving and processing data from various sources, the navigation-device 104 can maintain a high level of accuracy and reliability in its tracking and navigation predictions.

In an embodiment, the machine learning model in the navigation-device 104 can be trained based on the spatial guidance dataset. The machine learning model is configured to learn spatial patterns by analyzing relationships between the plurality of data signals and the navigational repository.

In an embodiment, the machine learning model determines a navigation signal for guiding a user. The navigation signal is generated by analyzing a user location and predicted movement patterns.

In an embodiment, the deep learning models include a navigation model to process the tracked data as input and predict the user's intended destination. The model analyzes historical movement patterns, user profile preferences, and real-time environmental conditions to forecast where the user is most likely heading. Using predictive algorithms, the model generates accurate destination predictions.

In an embodiment, the deep learning models include a communication model to convert the predicted destinations and navigation instructions into user-friendly text or audio messages. The communication model processes the navigation data and transforms it into clear, accessible outputs for the user. Based on the predictions, the navigation-device 104 generates real-time guidance through the indoor space. The guidance is delivered via text or audio messages, depending on the user's preference. The navigation-device 104 can deliver navigation instructions through text-based notifications or audio prompts.

The navigation-device 104 is configured to provide a navigation and communication interface at the terminal 106 for delivering the optimal navigation path once the user's position and intended destination are determined. The interface supports both text and audio outputs, ensuring accessibility for users with various disabilities. The navigation-device 104 generates clear, real-time instructions and communicates them through the terminal 106, such as smartphones or specialized assistive technologies. The interface can be customized based on the user's preferences, providing either auditory navigation for those with visual impairments or visual instructions for those who prefer text-based guidance.

In an embodiment, the navigation-device 104 is configured to provide emergency response integration for user safety. In the event of an emergency or if the user encounters difficulties, the navigation-device 104 can automatically alert facility staff or emergency services. The navigation-device 104 transmits the user's exact location, as determined through real-time tracking, to the appropriate response team.

The navigation-device 104 also collects and analyzes user interaction data received by the terminal 106, such as preferred paths, commonly visited destinations, and specific accessibility requirements. The data is used to tailor future navigation aids to the user's individual needs. For example, if a user frequently avoids stairways in favor of elevators, the system adjusts its route suggestions accordingly.

In an embodiment, the navigation-device 104 is configured to assist a visually impaired student navigating a university campus. As the student walks, the terminal 106 delivers audio cues through an earpiece, guiding them from their dormitory to classroom buildings. The navigation-device 104 detects obstacles such as staircases and issues real-time warnings. The device 104 may also suggest tactile paving for easier navigation, providing detailed instructions that adjust dynamically as the student moves across the campus.

In an embodiment, the navigation-device 104 identifies staircases, steps, doors, and other obstacles through sensor data and video feeds. The terminal 106 alerts the user to the presence of stairs, providing information about their direction and any available handrails. The navigation-device 104 also detects whether doors are open or closed and provides the user with appropriate instructions to navigate without physical contact. Areas with uneven flooring and low-hanging obstacles, such as tree branches or signs, are identified, reducing the risk of trips or collisions by alerting the user in real-time.

In an embodiment, the navigation-device 104 monitors crowded areas by analyzing crowd density data. The terminal 106 notifies the user of high-traffic areas to help them avoid potential collisions or uncomfortable crowding. The host processor 112 dynamically adjusts the route based on real-time crowd data, guiding the user along less crowded paths for a smoother and more efficient navigation experience.

In an embodiment, the navigation-device 104 detects tactile paving through the use of sensors and video cameras. The terminal 106 provides audio cues to inform the user of upcoming tactile surfaces, describing their patterns and meanings, such as the approach to a crosswalk or hazardous area. The feature allows visually impaired users to navigate confidently, understanding both their immediate surroundings and upcoming areas.

In an embodiment, the navigation-device 104 provides visual cues to individuals with autism, helping them navigate a shopping mall. The terminal 106 displays directions to favorite stores while avoiding crowded areas. The system integrates historical data to suggest visiting stores during quieter times.

In an embodiment, the navigation-device 104 provides a wheelchair user navigating a multi-story office building. The system highlights accessible routes using data from elevators and ramps, delivering real-time updates on their availability through the terminal 106. If an elevator or ramp is out of service, the host processor 112 calculates alternative routes to ensure the user can reach their destination without barriers.

In an embodiment, the navigation-device 104 is configured to guide an elderly person with mild cognitive difficulties through a large hospital. The terminal 106 displays simple, clear directions on the user's smartphone, reducing anxiety by providing step-by-step guidance.

In an embodiment, the navigation-device 104 is configured to assist a person recovering from a leg injury navigate a busy airport. The navigation-device 104 calculates the shortest route with minimal walking and guides the user to rest areas along the way. The terminal 106 provides text message updates, and the host processor 112 adjusts the route dynamically based on current airport conditions, such as gate changes or obstacles.

In an embodiment, the navigation-device 104 is configured to deliver visual navigation aids to a deaf individual at a public library. The terminal 106 helps the user locate specific book sections and provides real-time notifications about available library services. The host processor 112 processes sensor and video data to ensure smooth navigation, guiding the user through the library without difficulty.

In an embodiment, the navigation-device 104 provides personalized emergency evacuation guidance for individuals with disabilities, such as someone using a walker. The host processor 112 continuously monitors evacuation routes and dynamically adjusts guidance based on real-time crowd density data.

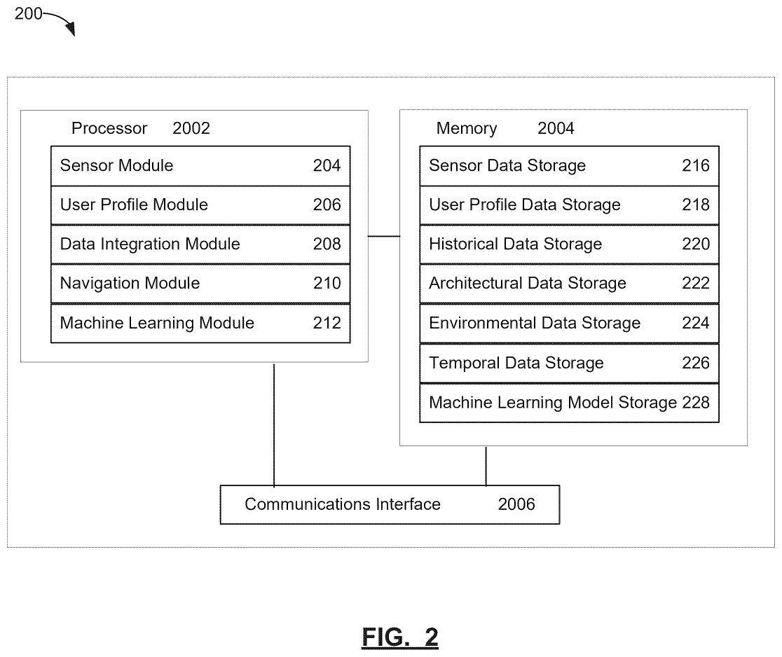

Reference is now made to FIG. 2, which illustrates an example block diagram of an indoor tracking and navigation-device. The device includes a processor, a memory, and a communications interface. The processor includes a sensor module, a user profile module, a data integration module, a navigation module, and a machine learning module. The memory includes a sensor data storage, user profile data storage, historical data storage, architectural data storage, environmental data storage, temporal data storage, and machine learning model storage. The processor 202 includes a sensor module 204, user profile module 206, data integration module 208, navigation module 210, and machine learning module 212. The device of FIG. 2 corresponds functionally to the navigation-device described with reference to FIG. 1; in FIG. 2, the memory includes a machine learning model storage 228 for local inference, and the communications interface 2006 may include a remote inference interface 230 for communication with a remote navigation server.

The memory 2004 includes a sensor data storage 216, user profile data storage 218, historical data storage 220, architectural data storage 222, environmental data storage 224, temporal data storage 226, and machine learning model storage 228.

The sensor module 204 is configured to acquire a plurality of sensor signals. The sensor module 204 can collect and process data from various sensors, including motion detectors, infrared sensors, and ultrasonic sensors, to support real-time navigation and environmental monitoring. The sensor data storage 216 is configured to store real-time sensor data collected from various input devices, including infrared sensors, ultrasonic sensors, and motion detectors, for further processing and analysis.

The sensor module 204 is configured to manage and process data from a plurality of sensors. The sensors may include pre-existing sensors in a building's infrastructure or newly installed sensors. The sensors include infrared sensors, ultrasonic sensors, and motion detectors. The sensors collect real-time data to support indoor tracking and navigation. The sensor data storage 216 is configured to receive and store the sensor data for subsequent processing, ensuring the data is readily accessible for the navigation-device's operations.

Before integrating the sensors, the sensor module 204 can perform an automated compatibility assessment to ensure that each sensor meets the device's 200 operational requirements. The compatibility assessment includes verifying data quality, update frequency, and coverage area. During this process, the sensor module 204 retrieves sensor parameters such as signal range, resolution, and data transmission rates from the sensor data storage 216 and cross-references them with predefined thresholds to confirm that the sensors are suitable for accurate indoor tracking. For instance, the sensor module 204 compares sensor outputs with known environmental features to evaluate positional accuracy and data reliability.

The sensor module 204 may execute latency and update frequency tests to measure the intervals between sensor data transmissions. The sensor module 204 evaluates whether these intervals meet the system's real-time processing needs, simulating navigation scenarios to validate that the sensors provide continuous and timely updates. Additionally, the sensor module 204 maps each sensor's coverage area using algorithms to detect potential gaps. The mapping process generates a visual map, viewable via a terminal, highlighting areas where additional sensors may be needed for comprehensive environmental monitoring and navigation accuracy.

The sensor module 204 continuously monitors sensor inputs for inconsistencies or performance degradation. If any gaps in coverage or insufficient update frequencies are detected, it flags the sensors that do not meet operational standards and generates alerts. In such cases, the sensor module 204 proposes optimized sensor placement or suggests the installation of additional sensors to maintain system integrity.

When the existing sensor network lacks sufficient coverage or data quality, the sensor module 204 integrates new sensors tailored to the environment's specific requirements. For example, the sensor module 204 may select infrared sensors for detecting movement in low-light areas or ultrasonic sensors for proximity detection in narrow spaces. The sensor module 204 is also configured for performing spatial mapping, identifying critical locations such as entry points, corridors, and stairwells to ensure optimal sensor placement for seamless tracking and navigation.

Once appropriate sensors are selected, the sensor module 204 determines the optimal placement using algorithms designed to maximize coverage while minimizing interference and overlap. The sensor module 204 may compute the best sensor positions in key areas, such as doorways, intersections, and shared spaces, for accurate and efficient tracking.

After new sensors are installed, the sensor module 204 initiates an automatic calibration process to adjust each sensor according to environmental conditions, such as light levels or surface reflections. The sensor module 204 synchronizes all sensors, aligning their data timestamps to ensure that real-time data is processed without delay or misalignment.

In some cases, the sensor module 204 operates in a hybrid mode, integrating both existing and newly installed sensors. The sensor module 204 analyzes the performance of the existing sensor network by assessing data quality, coverage, and real-time responsiveness. If any inefficiencies are detected, the sensor module 204 identifies optimal positions for new sensors to improve overall performance. The sensor module 204 then synchronizes data streams from both the old and new sensors, enabling seamless data fusion and consistent navigation accuracy.

The sensor module 204 can also complement sensor data with real-time video feeds from cameras. The video feeds capture visual information about the environment, detecting dynamic changes such as people moving through a hallway, temporary obstacles, or crowd density fluctuations. The sensor module 204 processes the video data using computer vision algorithms to detect and identify obstacles, adjusting navigation routes in real-time to ensure that the user's path remains accessible and safe.

The machine learning module 212 is configured to calculate optimal navigation routes based on a navigation repository including real-time sensor data, user profile data, and environmental data, dynamically adjusting routes as needed for efficiency and accessibility.

The architectural data storage 222 is configured to store detailed information about the building's layout and structural features, for providing accurate navigation. The stored data includes floor plans, locations of accessibility features such as elevators, ramps, doorways, and other essential building infrastructure. Upon receiving architectural data from architectural data storage 222, the navigation module 210 processes this data to generate accurate maps of the building's internal routes. The architectural data storage 222 provides that architectural data is organized and readily accessible for use by the navigation system. For example, when a user requires a wheelchair-accessible route, the navigation module 210 retrieves the relevant architectural data from the storage to map out a route that incorporates ramps, wide doorways, or accessible elevators.

The historical data storage 220 is configured to store time-stamped records of user movements within the indoor environment. The historical data includes frequently traveled routes, commonly visited destinations, and the amount of time spent at various locations. The historical data is collected over time and organized into a structured format, including fields such as location identifiers, timestamps, and durations of stay. Upon receiving historical data from the historical data storage 220, the navigation module 208 processes the historical data to identify user movement patterns. By analyzing these patterns, the navigation module 208 can predict future navigation needs and offer route suggestions tailored to individual user behaviors. For instance, if the historical data indicates that a specific user frequently visits a particular location at certain times, the system can preemptively suggest this destination or optimize the route based on past behaviors.

The user profile module 206 is configured to manage and store user-specific data, such as navigation preferences and accessibility requirements, enabling personalized navigation assistance for individual users. The user profile data storage 218 is configured to store detailed user profile data, including navigation preferences, accessibility needs, and feedback, allowing the system to provide customized navigation suggestions.

The user profile module 206 is configured to manage user-specific data, including navigation preferences and accessibility requirements. This data is stored in the user profile data storage 218. The user profile data includes unique identifiers for each user and corresponding navigation data. The navigation data comprises of preferred routes, frequently visited locations, and specific accessibility requirements, such as the need for wheelchair-accessible paths or preference for elevators.

The user profile module 206 enables the device 200 to personalize navigation based on user mobility preferences, such as avoiding stairs or selecting routes with accessible restrooms. The navigation module 210 can gather the user data automatically through sensors that track user interactions or manually via a user interface on a terminal. The user data is then stored in a structured profile format in the user profile data storage 218, which includes fields for route preferences, accessibility needs, and frequently visited locations. The navigation module 210 retrieves the user profile data to customize navigation suggestions based on the user's stored preferences.

The user profile data storage 218 also stores user feedback after each navigation session. The feedback may include satisfaction ratings, suggested route improvements, and accessibility challenges encountered. The user profile module 206 processes this feedback, categorizing it into areas such as route efficiency, accessibility, and user preferences. The data is then used by the navigation module 210 to refine future route predictions and improve personalized guidance.

The historical data storage 220 is configured to store time-stamped records of users'previous movements, commonly traveled routes, and frequently visited locations, facilitating predictive navigation and route optimization.

The environmental data storage 224 is configured to store real-time environmental data, such as crowd density, obstacles, and other dynamic changes in the indoor environment, ensuring that the system can adjust navigation routes in real-time.

The temporal data storage 226 is configured to store time-related patterns, such as frequently visited areas during specific times of day or days of the week, which helps in predicting user movements and adjusting navigation routes based on temporal factors.

The navigation module 210 is configured to process environmental data stored in the environmental data storage 224. The environmental data includes representations of user interactions with features such as elevators, doors, and kiosks. For instance, if a user calls an elevator, the navigation module 210 predicts the intention to move to another floor. The navigation module 210 also processes environmental data to adjust navigation routes in real-time. The navigation module 210 analyzes data from the environmental data storage 224 to detect temporary obstacles like construction zones or blocked pathways.

The navigation module 210 also processes temporal data stored in the temporal data storage 226 for predictive modeling of user destinations. The navigation module 210 retrieves time-stamped user movement data, including logs of previous navigation events and visits to specific locations, from the historical data storage 220. The navigation module 210 analyzes these temporal patterns to identify user behaviors related to specific times of the day.

The navigation module 210 stores these temporal patterns in a structured format within the temporal data storage 226, categorizing them for efficient retrieval. The navigation module 210 may also map frequent visits to locations such as cafeterias during lunchtime and associate these patterns with time intervals.

In an embodiment, the operations of the navigation module 210 can be performed by the machine learning module 212 by leveraging deep learning technologies.

The data integration module 208 is configured to process and integrate a plurality of data including the plurality of sensor signals and navigational repository to generate a spatial guidance dataset. The data integration module 208 executes predictive algorithms to analyze inputs such as sensor data, user profiles, historical data, architectural data, environmental data, and temporal data. The data integration module 208 utilizes advanced data fusion techniques to merge inputs into a unified data stream. The data integration module 208 synchronizes different data formats for real-time processing. The integrated dataset allows the data integration module 208 to generate personalized navigation suggestions. The data integration module 208 improves indoor tracking and navigation accuracy by fusing multimodal data. This includes data from the sensor data storage 216, user profile data storage 218, historical data storage 220, architectural data storage 222, environmental data storage 224, and temporal data storage 226. Historical data from the historical data storage 220 provides frequently traveled routes and common destinations, while user profiles in the user profile data storage 218 store personalized preferences like avoiding stairs or favoring elevators. After each navigation session, user feedback updates are used to refine future route suggestions. The navigation module 210 processes environmental and temporal data, such as crowd density or time of day, to offer accessible and optimal routes for each user.

In an embodiment, the data integration module 208 is configured to collect, preprocess, and synchronize data. The data integration module 208 receives real-time sensor and video data and pre-processes the data by removing noise, inconsistencies, and redundant information. The data integration module 208 can integrate sensor data to complement visual data from video streams. For example, ultrasonic sensors can measure the distance to nearby objects, improving spatial accuracy. The data integration module 208 processes ultrasonic data to refine obstacle locations detected by video feeds.

The data integration module 208 is configured to preprocess raw data received from an API before using it in neural network models. The preprocessing steps include data cleaning, which removes irrelevant or noisy data points, and data transformation, converting raw data into structured formats suitable for analysis. The data integration module 208 fills in gaps or missing values and normalizes the dataset to ensure consistency. The data integration module 208 applies fusion algorithms to reconcile data from various sources into a coherent model of the user's environment. The data integration module 208 allows the system to determine the user's indoor location without relying on GPS.

The data integration module 208 is configured to organize incoming data from individual beacons, improving the tracking of beacon movements and enhancing localization accuracy.

The data integration module 208 implements multiple fusion techniques to enhance the accuracy and reliability of its location predictions. The module uses feature fusion to extract relevant data from both sensor and video inputs, combining them to make more accurate predictions. The data integration module 208 can integrate architectural data stored in the architectural data storage 222 to improve navigation suggestions.

The data integration module 208 can perform time synchronization techniques to ensure that data streams from multiple sources, such as sensors, video feeds, and building management systems, are aligned.

The machine learning module 212 is configured to be trained on the spatial guidance dataset. The machine learning model is configured to learn spatial patterns by analyzing relationships between the plurality of data signals and the navigational repository. The machine learning module 212 transform raw sensor data into formats suitable for processing by its algorithms. For example, grid maps are processed by Convolutional Neural Networks (CNNs) for location tracking. RSSI (Received Signal Strength Indicator) values are converted into visual formats for the network.

The navigation module 210 continuously tracks the user's position and movement trajectory using sensor and video data. It integrates inputs from motion detectors, infrared sensors, and video feeds to update the user's location in real-time. The navigation module 210 uses fusion algorithms to calculate the user's current position and predict the intended destination by analyzing real-time movement patterns alongside historical and user profile data.

The navigation module 210 extracts relevant features from video streams and data signals for navigation purposes. The navigation module 210 uses computer vision techniques to identify static landmarks like walls and doors. To detect dynamic obstacles such as moving people or barriers, the module applies edge detection and motion tracking algorithms.

The machine learning module 212 is equipped with deep learning models that support indoor tracking and navigation. The models learn spatial patterns from multimodal data, such as sensor and video inputs, to track the user's position in real-time. The machine learning module 212 includes a hybrid neural network that combines CNNs and Artificial Neural Networks (ANNs) for indoor localization. It transforms input data, such as RSSI values, into a grayscale matrix representing signal strength from Wi-Fi beacons. The machine learning module 212 executes deep learning models that analyze and interpret multimodal data from sensors and video feeds. These models are trained for tasks like object recognition, motion analysis, and environmental mapping.

The machine learning model storage 228 is configured to store pre-trained machine learning models used for tasks such as route optimization, object detection, and user intent prediction, ensuring the system can apply advanced analytics for accurate navigation.

The machine learning module 212 is configured to determine a navigation signal for guiding a user, wherein the navigation signal is generated by analyzing a user location and predicted movement patterns. The machine learning module 212 implements predictive algorithms to anticipate user movement patterns, especially for users with disabilities. The module refines its predictions over time, adapting to users'navigation preferences based on historical behavior and current environmental conditions. The machine learning module 212 continuously analyzes multimodal data to make accurate predictions about user positions and destinations. These deep learning models can adapt to new environmental conditions and user behaviors, improving the system's performance.

The machine learning module 212 employs a CNN (Convolutional Neural Network) structure to optimize feature extraction. The initial layers detect spatial patterns from the input matrix, providing the device 200 to condense raw data into meaningful representations. Max-pooling layers are used to reduce the complexity of the data while preserving key features. Once flattened, the data is passed through a fully connected ReLU-activated network, refining the features further before classification. For classification and output, the SoftMax activation layer generates probability distributions across possible user locations.

The machine learning module 212 utilizes a hybrid model combining CNNs and ANNs, which offers an alternative to traditional algorithms like K-Nearest Neighbors (KNN). The CNN used in the hybrid model comprises of several layers. These include a convolutional ReLU-activated layer with a 7×7 kernel, followed by a 2×2 max-pooling layer to reduce spatial dimensions and focus on important features. Another ReLU-activated layer with a 3×3 kernel is followed by a 2×2 max-pooling layer. Once feature extraction is complete, the output passes through a SoftMax activation layer. This generates probability vectors indicating the likelihood of the user being in one of 21 predefined zones.

The machine learning module 212 trains tracking and navigation models using preprocessed datasets collected from the indoor environment. These datasets include sensor signals, video feeds, and user movement patterns. The models undergo several training epochs, during which they learn to detect spatial patterns and predict destinations.

After training and validation, the models are integrated into a unified application for indoor tracking and navigation. The machine learning module 212 deploys these models within a real-time processing framework.

The machine learning module 212 uses CNNs and Graph Neural Networks (GNNs) for environmental mapping. The deep learning models generate dynamic maps of the indoor environment. The machine learning module 212 is also configured for user intent prediction. The machine learning module 212 updates its spatial mapping as the environment changes. The machine learning module 212 uses deep learning models to construct and update a 3D map of the indoor environment. Pattern recognition models within the machine learning module 212 analyze data over time to improve tracking precision. By learning from user movement patterns and environmental changes, the module 212 refines common navigation routes and obstacle detection. This improves the accuracy and reliability of the tracking system.

The machine learning module 212 executes adaptive navigation algorithms that dynamically adjust suggested routes. These algorithms consider real-time environmental factors like obstacles, user speed, and conditions to calculate the most efficient path. The machine learning module 212 also processes external factors like event schedules, area occupancy, and crowd density. The module integrates event data, such as time, location, and nature, into predictive models to forecast user movements toward event venues.

In an embodiment, the machine learning module 212 provides a feedback loop, allowing users to provide real-time feedback on route effectiveness and comfort. Users can report obstacles or rate the accessibility of suggested routes. The feedback is processed and incorporated into the data analysis and fusion processes. The machine learning module 212 is configured for dynamic re-routing. If an accessible route becomes unavailable due to maintenance or blockages, such as a broken elevator or blocked ramp, the system recalculates and suggests an alternative accessible route.

In an embodiment, the machine learning module 212 integrates with building management systems. The module 212 receives updates about maintenance schedules, emergency situations, and changes affecting accessibility. These updates allow the system to adapt routes accordingly. The machine learning module 212 can provide intuitive user interaction through deep learning models. For visually impaired users, the communications interface 2006 delivers audio cues at a user terminal, offering clear guidance through the indoor environment.

In an embodiment, the machine learning module 212 is integrated with emergency response systems. In an emergency or if a user encounters difficulties, the machine learning module 212 automatically alerts facility staff or emergency services. The module 212 transmits the user's real-time location to the appropriate response team.

The communications interface 2006, connected with the processor 2002 and memory 2004, provides a primary medium through which the user interacts with the navigation-device 200. The interface 2006 can be connected to a display, terminal, smartphone, computer, or specialized assistive device. Through the communication interface 2006, users receive detailed navigation instructions that guide them through indoor spaces. The interface 2006 provides for delivering real-time route information, alerts about obstacles, and updates about accessible paths, ensuring that users receive timely guidance tailored to their individual needs. For users with visual impairments, the interface 2006 can provide audio cues that guide them step-by-step, while users with mobility challenges can receive notifications about routes that avoid stairs and prioritize elevators or ramps.

The communication interface 2006 collects and processes information from different modules within the device 200. Data from the navigation module 210, including real-time user position and movement patterns, is transmitted to the interface 2006 to keep users updated on their current location and destination. The user profile module 206 sends user-specific preferences such as preferred routes or accessibility requirement to the interface 2006. Additionally, feedback from the machine learning module 212, including dynamically adjusted routes based on environmental conditions, is communicated to the user through the interface 2006.

In a local-inference embodiment, the machine learning model storage 228 maintains a trained machine learning model resident in memory. One or more processors are configured to compute, using the trained machine learning model stored in the machine learning model storage 228, a navigation signal responsive to a user location and predicted movement patterns, thereby reducing latency and enabling operation when network connectivity is constrained.

In a remote-inference embodiment, the device communicates with a remote navigation server that stores a trained machine learning model. The device includes a remote inference interface 230 implemented via the communications interface 2006. The remote inference interface 230 is configured to transmit the navigational repository and a plurality of sensor signals to the remote navigation server and to receive a navigation signal computed by the remote navigation server using the trained machine learning model. The device then presents the navigation signal to the user via the communications interface 2006 and associated output components.

In some embodiments, the device supports hybrid operation that selectively performs local or remote inference based on resource availability, policy constraints, or real-time conditions. For example, the device may default to local inference when network connectivity is limited or latency requirements are strict, and may request remote inference when the server offers enhanced models, broader environmental context, or updated architectural data. The device is configured to synchronize the local trained machine learning model with the remote model periodically or upon availability of updated weights, thereby maintaining consistency while enabling continuous improvements. Fallback mechanisms may be implemented to ensure uninterrupted guidance, wherein the device automatically switches to local inference if remote services are unavailable.

In an embodiment, the on-device memory maintains versioned model artifacts and associated metadata indicating training time, dataset provenance, and performance metrics. The device may validate compatibility between the local model and the navigational repository, and perform staged updates to minimize disruption. In remote-inference configurations, the device may transmit a minimal feature representation derived from the fusion of sensor signals and the navigational repository, reducing bandwidth while preserving the accuracy needed for route computation at the server. In both configurations, time synchronization is maintained across data streams to ensure coherent generation of the tempospatial guidance dataset and precise computation of the navigation signal.

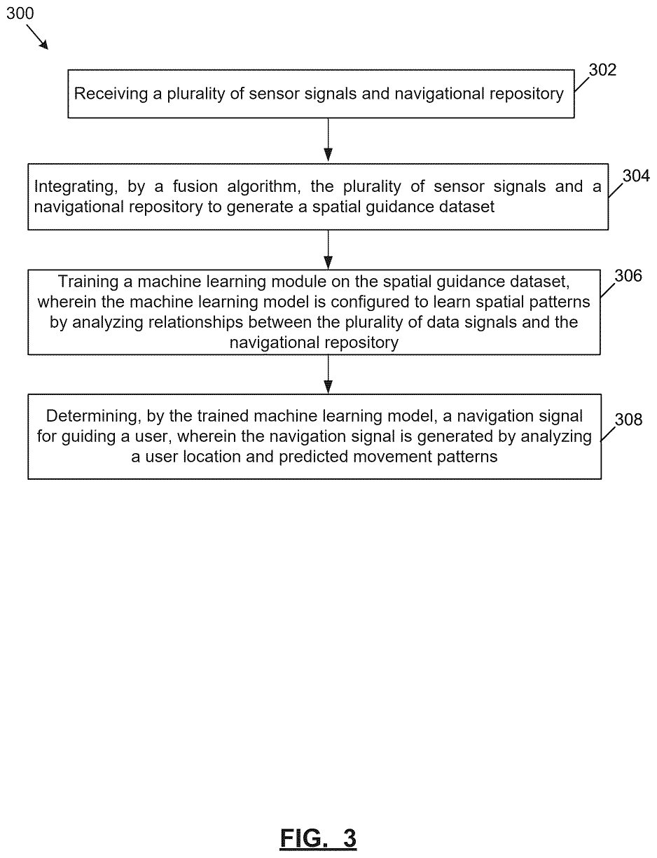

Reference is now made to FIG. 3, which shows a flowchart 300 of an example method for processing indoor tracking and navigation. The method 300 can be implemented by the host processor 112 of the navigation-device 104 of FIG. 1.

In an embodiment, the indoor navigation-device stores a trained machine learning model locally in memory and performs on-device inference. The device includes a communication interface configured to receive a plurality of sensor signals from external sensors and cameras, and a memory storing both a navigational repository comprising architectural data, historical data, environmental data, and user profile data, and the trained machine learning model. One or more processors are configured to integrate, by a multimodal fusion algorithm, the plurality of sensor signals and the navigational repository to generate a tempospatial guidance dataset, and to compute, using the trained machine learning model stored in memory, a navigation signal for guiding a user. The on-device inference reduces latency, enables operation in network-constrained environments, and supports privacy-preserving processing by keeping sensitive data and model execution local to the device.

In an embodiment, the indoor navigation-device interfaces with a remote navigation server that stores a trained machine learning model and performs inference remotely. The device transmits, via its communication interface and the remote inference interface 230, the navigational repository and a plurality of sensor signals to the remote navigation server. The server integrates, by a fusion algorithm, the transmitted sensor signals and navigational repository to generate a tempospatial guidance dataset and computes, using the trained machine learning model resident at the server, a navigation signal. The device then receives the navigation signal from the server and presents guidance to the user. This remote-inference embodiment centralizes model execution and updates, facilitates coordinated building-wide optimization across multiple devices, and allows the server to leverage additional data sources, such as building management systems and aggregated environmental feeds, to enhance route computation.

In some embodiments, the device supports hybrid operation that selectively performs local or remote inference based on resource availability, policy constraints, or real-time conditions. For example, the device may default to local inference when network connectivity is limited or latency requirements are strict, and may request remote inference when the server offers enhanced models, broader environmental context, or updated architectural data. The device is configured to synchronize the local trained machine learning model with the remote model periodically or upon availability of updated weights, thereby maintaining consistency while enabling continuous improvements. Fallback mechanisms may be implemented to ensure uninterrupted guidance, wherein the device automatically switches to local inference if remote services are unavailable.

In an embodiment, the on-device memory maintains versioned model artifacts and associated metadata indicating training time, dataset provenance, and performance metrics. The device may validate compatibility between the local model and the navigational repository, and perform staged updates to minimize disruption. In remote-inference configurations, the device may transmit a minimal feature representation derived from the fusion of sensor signals and the navigational repository, reducing bandwidth while preserving the accuracy needed for route computation at the server. In both configurations, time synchronization is maintained across data streams to ensure coherent generation of the tempospatial guidance dataset and precise computation of the navigation signal.

At 302, the method includes receiving a plurality of sensor signals and navigational repository. The navigational repository include architectural data, historical data, user profile data, and real-time environmental sensing data.

The method includes receiving architectural data, which comprises building layouts and structural details. The data includes the identification of elevators, ramps, doorways, and other accessibility features.

The method further includes receiving historical data, which captures individual user movements within the indoor environment. The historical data includes frequently taken routes, commonly visited locations, and the time spent in specific areas.

The method includes receiving user profile data, which comprises user identifiers and corresponding navigation data. The user profile data includes preferred routes, frequently visited destinations, and accessibility requirements such as preferences for wheelchair-accessible paths or elevator usage.

The method also includes receiving real-time environmental sensing data from sensors, which capture dynamic changes in the environment, such as obstacles or crowd density.

The method further includes receiving user feedback after navigation sessions. The feedback may include satisfaction ratings, suggestions for route improvements, or reports of accessibility challenges encountered.

In an embodiment, the method includes performing an automated compatibility assessment for sensors before integrating them into the navigation system. The method further includes retrieving sensor parameters such as signal range, resolution, and data transmission rates, and comparing them against predefined thresholds to verify sensor suitability for indoor tracking and navigation.

In an embodiment, the method includes performing latency and update frequency tests by measuring the time intervals between sensor data transmissions. The method evaluates whether these intervals meet real-time processing requirements, simulating navigation scenarios to validate the sensors'ability to provide continuous, real-time updates. The method also includes monitoring sensor inputs for inconsistencies or performance degradation.

The method further includes receiving and processing temporal data, which provides insight into user movement patterns associated with specific times of the day or week. By analyzing time-stamped movement data, such as frequent visits to entry points during morning hours or lunch breaks in common areas, the system predicts future user destinations.

At 304, the method includes integrating, by a fusion algorithm, the plurality of sensor signals and a navigational repository to generate a tempospatial guidance dataset. The integration process combines sensor data, user profiles, historical data, architectural data, environmental data, and temporal data. The fusion algorithm synchronizes the diverse data formats, enabling real-time processing and ensuring seamless integration. By merging these inputs, the method generates a comprehensive understanding of the indoor environment, accounting for both static elements, such as walls and doors, and dynamic factors, such as moving obstacles and crowd density.

The fusion algorithm processes multimodal data from various sensors, including infrared, ultrasonic, and motion detectors, as well as real-time video streams. This allows the system to map the environment accurately and continuously monitor changes. The method further leverages predictive algorithms to analyze the integrated dataset, predicting user destinations and generating optimized routes.

In an embodiment, the integration includes combining sensor data with visual information to refine spatial accuracy. For instance, ultrasonic data measures the distance to nearby objects, while infrared sensors detect heat signatures, allowing the system to differentiate between static obstacles and moving individuals. This multimodal data is fused to create a comprehensive representation of the indoor environment, enhancing object detection and localization accuracy.

The integration further includes the application of fusion algorithms to merge data from various sensor types and video feeds. In an embodiment, these fusion algorithms reconcile different data types, providing a coherent model of the user's environment. This allows the system to dynamically adjust navigation instructions based on real-time conditions, such as crowd density or temporary obstacles.

In another embodiment, the integration process includes utilizing architectural data alongside sensor and video data to provide contextual navigation suggestions. The system integrates building layouts, including information on elevators, ramps, and doorways, to dynamically check the availability and status of accessibility features.

At 306, the method includes training a machine learning module on the tempospatial guidance dataset, wherein the machine learning model is configured to learn spatial patterns by analyzing relationships between the plurality of data signals and the navigational repository. The machine learning model is configured to learn spatial patterns by analyzing the relationships between sensor data, user movements, and environmental changes within the indoor environment. The model utilizes convolutional neural networks (CNNs) to detect key spatial features and continuously refines its predictions based on new incoming data, enabling accurate real-time indoor localization and tracking.

At 308, the method includes determining, by the trained machine learning model, a navigation signal for guiding a user, wherein the navigation signal is generated by analyzing a user location and predicted movement patterns. This signal is generated by analyzing the user's real-time location, predicted movement patterns, and environmental conditions. The signal may suggest accessible routes, adjust navigation based on crowd density, or provide alternative paths when obstacles are detected, ensuring personalized and dynamic navigation for users.

Additionally, the method includes processing input data using a hybrid neural network model that combines CNNs and artificial neural networks (ANNs). The CNNs process the spatial features from sensor inputs, while the ANN predicts the user's precise location within the environment based on these features. This hybrid model improves the accuracy of indoor localization by integrating multiple data sources, such as Received Signal Strength Indicator (RSSI) data from Wi-Fi beacons, into a unified representation for enhanced location tracking.

In an embodiment, the method further includes deploying deep learning models to analyze the rich multimodal data in real-time. The models handle tasks such as object recognition, motion analysis, and environmental mapping. The CNN architecture detects obstacles, such as walls or furniture, and tracks moving elements, like people or temporary barriers, while Recurrent Neural Networks (RNNs) analyze user movement patterns over time.

In an embodiment, the method includes executing a feedback mechanism where the system dynamically adapts its navigation predictions based on real-time environmental data and user behaviors. This includes leveraging predictive algorithms to anticipate movement patterns of users with disabilities or special navigation preferences. The models learn from historical data and user interactions to offer optimized routes, which improve over time as the system continuously refines its predictions based on new inputs.

The method includes applying a feature extraction process within the CNN architecture to condense raw spatial data into meaningful representations. The CNN extracts critical features, which are then passed through multiple layers, such as max-pooling and fully connected layers, to reduce the complexity of the data while retaining information.

The method includes performing environmental mapping using a combination of Convolutional Neural Networks (CNNs) and Graph Neural Networks (GNNs). The CNNs detect spatial features while the GNNs analyze the relationships between different elements within the indoor environment. These deep learning models generate dynamic maps of the environment that are continuously updated with sensor and video data.

In an embodiment, the method includes predicting user intent by analyzing movement patterns and previous navigation choices. The machine learning model uses decision trees and Bayesian networks to predict the user's intended destination.

The method further includes updating the spatial mapping feature as the environment changes. Deep learning models continuously construct and refine the three-dimensional map, incorporating both static and dynamic environmental changes.

In an embodiment, the method includes executing adaptive navigation algorithms that dynamically adjust suggested routes based on real-time environmental data and the user's current status. The algorithms consider factors like obstacles, user speed, and environmental conditions to calculate the most efficient path from the user's current location to their intended destination.

The method also includes processing external factors, such as event schedules, crowd density, and area occupancy. If a building hosts events, the system receives data regarding the time, location, and nature of the event.

At 408, the method includes sending a navigation signal to the communication interface. The signal comprises real-time route information. The communication interface may include output devices, such as a display, terminal, smartphone, or assistive device. For visually impaired users, the navigation signal may include audio cues, while users with mobility challenges receive notifications about accessible paths that avoid obstacles like stairs and prioritize ramps or elevators.

The above interfaces are one of the outputs of the disclosed systems, devices, and methods. Any other implementation can be provided, and it is not limited to the specific implementation described. Further, the technical processes in the background, as detailed in other parts of this document, should be read in coherence while noting the technical improvements and efficiency achieved in the disclosed systems, devices, and methods.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. An indoor navigation platform comprising: a communication interface; a memory storing a navigational repository comprising architectural data, historical data, environmental data, and user profile data; and one or more processors configured to: receive, via the communication interface, a plurality of sensor signals from external sensors and cameras and location information from user terminals; integrate, by a fusion algorithm executed by the one or more processors, the plurality of sensor signals and the navigational repository to generate a tempospatial guidance dataset; train a machine learning model based on the tempospatial guidance dataset, wherein the machine learning model is configured to learn tempospatial patterns by analyzing relationships between the plurality of data signals and the navigational repository; determine, using the machine learning model, a navigation signal for guiding a user by analyzing a user location and predicted movement patterns; and transmit, via the communication interface, the navigation signal to a user terminal.

2. The platform of claim 1, wherein the plurality of sensor signals include at least two modalities selected from video streams, motion detection data, location data, and environmental data.

3. The platform of claim 1, wherein the navigational repository includes architectural data comprising building layouts and locations of elevators, ramps, doorways, and accessibility features.

4. The platform of claim 1, wherein the navigational repository includes user profile data comprising accessibility requirements, wheelchair-accessible paths, avoidance of stairs, and preferred elevator usage.

5. The platform of claim 1, wherein the machine learning model is configured to continuously fine-tune predictions by analyzing the plurality of sensor signals and the navigational repository to adapt dynamically to changes in an indoor environment.

6. The platform of claim 1, wherein the one or more processors are configured to analyze temporal data comprising time-stamped user movement patterns to predict peak usage times and determine optimal navigation routes based on the temporal data.

7. The platform of claim 1, further comprising a natural-language interaction module executed by the one or more processors and configured to: receive, via the communication interface, a user query expressed in natural language; process the query using a large language model to extract a destination and one or more constraints; translate the extracted information into structured navigation parameters; and generate the navigation signal responsive to the structured navigation parameters.

8. The platform of claim 1, wherein the communication interface is configured to authenticate user terminals and external systems and to encrypt transmissions of the plurality of sensor signals and the navigation signal.

9. The platform of claim 1, wherein access to the navigational repository is governed by role-based permissions enforced by the one or more processors, the role-based permissions limiting retrieval and update operations to authorized principals.

10. The platform of claim 1, wherein the one or more processors are configured to apply data minimization policies that restrict transmission of raw video frames and personally identifiable information, and instead transmit a minimal feature representation derived from the tempospatial guidance dataset.

11. An indoor navigation device comprising: a communication interface; a memory storing a trained machine learning model and a navigational repository comprising architectural data, historical data, environmental data, and user profile data; and one or more processors configured to: receive, via the communication interface, a plurality of sensor signals from external sensors and cameras; integrate, by a multimodal fusion algorithm, the plurality of sensor signals and the navigational repository to generate a tempospatial guidance dataset; and determine, using the trained machine learning model stored in the memory, a navigation signal for guiding a user.

12. The device of claim 11, wherein the plurality of sensor signals include motion detection data, infrared data, ultrasonic data, and video streams representing environmental conditions and user movements.

13. The device of claim 11, wherein the navigational repository includes architectural data comprising building layouts and locations of elevators, ramps, doorways, and accessibility features.

14. The device of claim 11, wherein the one or more processors are configured to perform on-device inference for sensitive categories of user profile data and to restrict transmission of such sensitive categories to a minimal feature representation.

15. The device of claim 11, further comprising a remote inference interface implemented via the communication interface and configured to transmit the navigational repository and the plurality of sensor signals to a remote navigation server that stores a trained machine learning model and to receive, via the communication interface, a navigation signal computed by the remote navigation server using the trained machine learning model.

16. The device of claim 11, wherein the one or more processors are configured to generate audit logs comprising time-stamped records of access to the navigational repository and navigation signal transmissions and to store the audit logs in the memory.

17. An indoor navigation method performed by a server, the method comprising: receiving, via a communication interface of the server, a plurality of sensor signals from external sensors and cameras and accessing a navigational repository stored in memory of the server, the navigational repository comprising architectural data, historical data, environmental data, and user profile data; integrating, by a fusion algorithm executed by one or more processors of the server, the plurality of sensor signals and the navigational repository to generate a tempospatial guidance dataset; training, by the one or more processors, a machine learning model based on the tempospatial guidance dataset, wherein the machine learning model is configured to learn tempospatial patterns by analyzing relationships between the plurality of data signals and the navigational repository; determining, by the one or more processors using the machine learning model, a navigation signal for guiding a user by analyzing a user location and predicted movement patterns; and transmitting, via the communication interface, the navigation signal to a user terminal.

18. The method of claim 17, wherein receiving the plurality of sensor signals comprises receiving at least two modalities selected from video streams, motion detection data, location data, and environmental data.

19. The method of claim 17, wherein training the machine learning model comprises continuously fine-tuning predictions by analyzing the plurality of sensor signals and the navigational repository to adapt dynamically to changes in an indoor environment.

20. The method of claim 17, further comprising pseudonymizing, by the one or more processors, user identifiers in the navigational repository prior to generating the navigation signal and enforcing retention policies that automatically expire or redact historical data and user feedback data after a predefined retention interval.
